(19) United States
(12) Patent Application Publication
(10) Pub. No.: US 2011/0013724 A1
(43) Pub. Date: Jan. 20, 2011

(54) I/Q IMBALANCE ESTIMATION AND COMPENSATION FOR A TRANSMITTER AND A RECEIVER

(75) Inventors: Leon Teruo Metreaud, Pepperell, MA (US); Hakan Inanoglu, Acton, MA (US); Xiangdong Zhang, Westford, MA (US); Zhengi Q. Chen, Acton, MA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/429,723

(22) Filed: Apr. 24, 2009

(51) Int. Cl. H04L 27/08; H04L 27/00; H04L 25/03

(52) U.S. Cl. 375/296; 375/316; 375/345; 375/295

(57) ABSTRACT

Techniques for performing inphase/quadrature (I/Q) imbalance estimation and compensation are described. In one exemplary design, I/Q imbalances in a receiver may be estimated by (i) applying a continuous wave signal at different frequencies to the receiver and (ii) processing I and Q input samples from the receiver to determine I/Q imbalances at different frequencies. In another exemplary design, I/Q imbalances may be estimated by (i) downconverting an input RF signal with an LO signal that is offset in frequency from the input RF signal, (ii) transforming I and Q input samples from the receiver to the frequency domain to obtain I and Q symbols, and (iii) determining I/Q imbalances based on the I and Q symbols. In one exemplary design, I/Q imbalances may be corrected by compensating for frequency-dependent and frequency-independent I/Q imbalances separately. I/Q imbalances in a transmitter may also be estimated and compensated.

### BACKGROUND

I. Field

The present disclosure relates generally to electronics, and more specifically to techniques for improving performance of a transmitter and a receiver.

II. Background

A wireless communication device such as a cellular phone typically includes a transmitter and a receiver to support bi-directional communication. The transmitter may condition and upconvert inphase (I) and quadrature (Q) output baseband signals with transmit local oscillator (LO) signals to obtain an output radio frequency (RF) signal that is more suitable for transmission via a wireless channel. The receiver may receive an input RF signal via the wireless channel and may downconvert the input RF signal with receive LO signals to obtain I and Q input baseband signals.

The transmitter typically includes an I branch and a Q branch to condition and quadrature upconvert the I and Q output baseband signals. The receiver also typically includes an I branch and a Q branch to quadrature downconvert the input RF signal and condition the I and Q input baseband signals. The I and Q branches may also be referred to as I and Q paths, etc. Ideally, for both the transmitter and the receiver, the I branch should be in quadrature (or 90° out of phase) with respect to the Q branch, and the two branches should have equal gain. However, I/Q imbalances typically exist between the I and Q branches and may include gain imbalance and/or phase error. Gain imbalance refers to error between the gains of the I and Q branches. Phase error refers to deviation/error from quadrature between the I and Q branches. The I/Q imbalances may degrade the performance of the transmitter and the receiver.

### BRIEF DESCRIPTION OF THE DRAWINGS

FIG. 1 shows a block diagram of a wireless communication device.

FIG. 2 shows a block diagram of a receiver.

FIG. 3 shows downconversion of an input RF signal during normal operation.

FIG. 4 shows downconversion of the input RF signal for I/Q imbalance estimation.

FIG. 5 shows a block diagram of a receive I/Q imbalance compensation unit.

FIG. 6 shows a process for estimating I/Q imbalances in the receiver.

FIG. 7 shows another process for estimating I/Q imbalances in the receiver.

FIG. 8 shows a process for compensating for I/Q imbalances in the receiver.

FIG. 9 shows a block diagram of a transmitter.

FIG. 10 shows a block diagram of a transmit I/Q imbalance compensation unit.

FIG. 11 shows a process for estimating I/Q imbalances in the transmitter.

FIG. 12 shows a process for compensating for I/Q imbalances in the transmitter.

### DETAILED DESCRIPTION

The word “exemplary” is used herein to mean “serving as an example, instance, or illustration.” Any design described herein as “exemplary” is not necessarily to be construed as preferred or advantageous over other designs.

I/Q imbalance estimation and compensation techniques are described herein. These techniques may be used for various electronics devices such as wireless communication devices, cellular phones, personal digital assistants (PDAs), handheld devices, wireless modems, laptop computers, cordless phones, Bluetooth devices, broadcast receivers, etc. For clarity, the use of the techniques for a wireless communication device is described below.

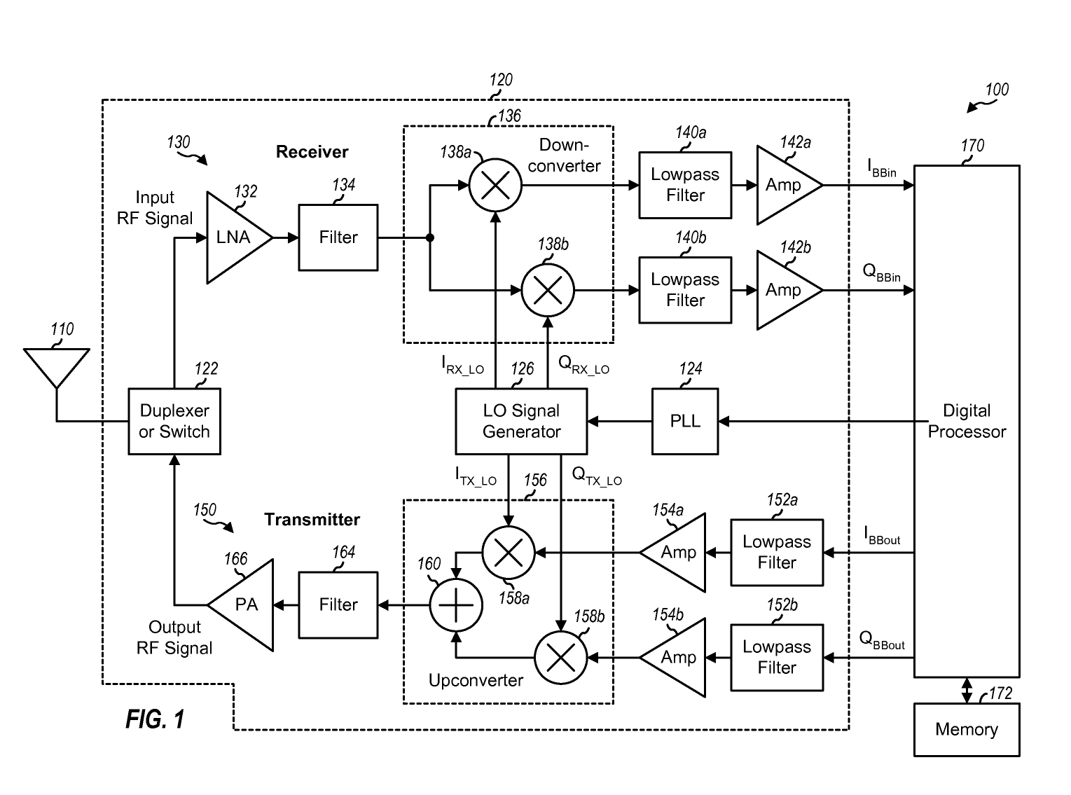

FIG. 1 shows a block diagram of an exemplary design of a wireless communication device 100, which may be a cellular phone or some other device. In the exemplary design shown in FIG. 1, wireless device 100 includes a transceiver 120, a digital processor 170, and a memory 172. Transceiver 120 includes a receiver 130 and a transmitter 150 that support bi-directional communication. In general, wireless device 100 may include any number of receivers and any number of transmitters for any number of communication systems and any number of frequency bands.

A receiver or a transmitter may be implemented with a super-heterodyne architecture or a direct-conversion architecture. In the super-heterodyne architecture, a signal is frequency converted between RF and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the exemplary design shown in FIG. 1, receiver 130 and transmitter 150 are implemented with the direct-conversion architecture.

In the receive path, an antenna 110 receives signals transmitted by base stations and/or other transmitter stations and provides an input RF signal, which is routed through a duplexer or switch 122 and provided to receiver 130. Within receiver 130, the input RF signal is amplified by a low noise amplifier (LNA) 132 and filtered by a filter 134 to obtain a filtered RF signal. A downconverter 136 receives the filtered RF signal and I and Q receive (RX) LO signals (I_{RX}_{_{—}}_{LO} and Q_{RX}_{_{—}}_{LO}) from an LO signal generator 126. Within downconverter 136, a mixer 138a downconverts the filtered RF signal with the I RX LO signal and provides an I downconverted signal. A mixer 138b downconverts the filtered RF signal with the Q RX LO signal and provides a Q downconverted signal. Lowpass filters 140a and 140b filter the I and Q downconverted signals, respectively, to remove undesired images, undesired signals, out-of-band noise, interference, etc., and provide I and Q filtered signals. Amplifiers (Amp) 142a and 142b amplify the I and Q filtered signals, respectively, to obtain the desired signal amplitude and provide I and Q input baseband signals (I_{BBin} and Q_{BBin}) to digital processor 170.

In the transmit path, digital processor 170 processes data to be transmitted and provides I and Q output baseband signals (I_{BBout} and Q_{BBout}) to transmitter 150. Within transmitter 150, lowpass filters 152a and 152b filter the I and Q output baseband signals, respectively, to remove undesired images caused by the prior digital-to-analog conversion. Amplifiers 154a and 154b amplify the signals from lowpass filters 152a and 152b, respectively, and provide I and Q amplified signals. An upconverter 156 receives the I and Q amplified signals and I and Q transmit (TX) LO signals (I_{TX}_{_{—}}_{LO} and Q_{TX}_{_{—}}_{LO}) from LO signal generator 126. Within upconverter 156, a mixer 158a upconverts the I amplified signal with the I TX LO signal, a mixer 158b upconverts the Q amplified signal with the Q TX LO signal, and a summer 160 sums the outputs of mixers 158a and 158b and provides an upconverted signal. A filter 164 filters the upconverted signal to remove images caused by the frequency upconversion as well as noise in a receive frequency band. A power amplifier (PA) 166 amplifies the signal from filter 164 to obtain the desired output power level and provides an output RF signal. The output RF signal is routed through duplexer or switch 122 and transmitted via antenna 110.

LO signal generator 126 generates the I and Q RX LO signals used by receiver 130 for frequency downconversion as well as the I and Q TX LO signals used by transmitter 150 for frequency upconversion. A phase locked loop (PLL) 124 receives timing information from digital processor 170 and generates control signals used to adjust the frequency and/or phase of the RX LO signals and the TX LO signals provided by LO signal generator 126.

FIG. 1 shows an exemplary design of a transceiver. In general, the conditioning of the signals in a transmitter and a receiver may be performed by one or more stages of amplifier, filter, upconverter, downconverter, etc. These circuit blocks may be arranged differently from the configuration shown in FIG. 1. Furthermore, other circuit blocks not shown in FIG. 1 may also be used to condition the signals in the transmitter and receiver. Some circuit blocks in FIG. 1 may also be omitted. All or a portion of transceiver 120 may be implemented on one or more analog integrated circuits (ICs), RF ICs (RFICs), mixed-signal ICs, etc.

Digital processor 170 may include various processing units for data transmission and reception and other functions. For example, digital processor 170 may include a digital signal processor (DSP), a reduced instruction set computer (RISC) processor, a central processing unit (CPU), etc. Memory 172 may store program codes and data for wireless device 100. Digital processor 170 and/or memory 172 may be implemented on one or more application specific integrated circuits (ASICs) and/or other ICs.

Receiver 130 may have I/Q imbalances, which may result from circuit blocks in the I branch (e.g., mixer 138a, lowpass filter 140a, and amplifier 142a) not matching circuit blocks in the Q branch (e.g., mixer 138b, lowpass filter 140b, and amplifier 142b). I/Q imbalances may result from gain imbalance between the I and Q branches and phase error between the I and Q branches. I/Q imbalances may also result from different frequency responses for the I and Q branches. In any case, I/Q imbalances may degrade the performance of receiver 130.

In an aspect, I/Q imbalances in receiver 130 may be estimated and compensated in order to improve the performance of the receiver. I/Q imbalances may be estimated for different frequencies to obtain frequency-dependent gain imbalances and phase errors between the I and Q branches of the receiver. I/Q imbalances may then be compensated across frequency, which may provide better performance than compensation at a single frequency.

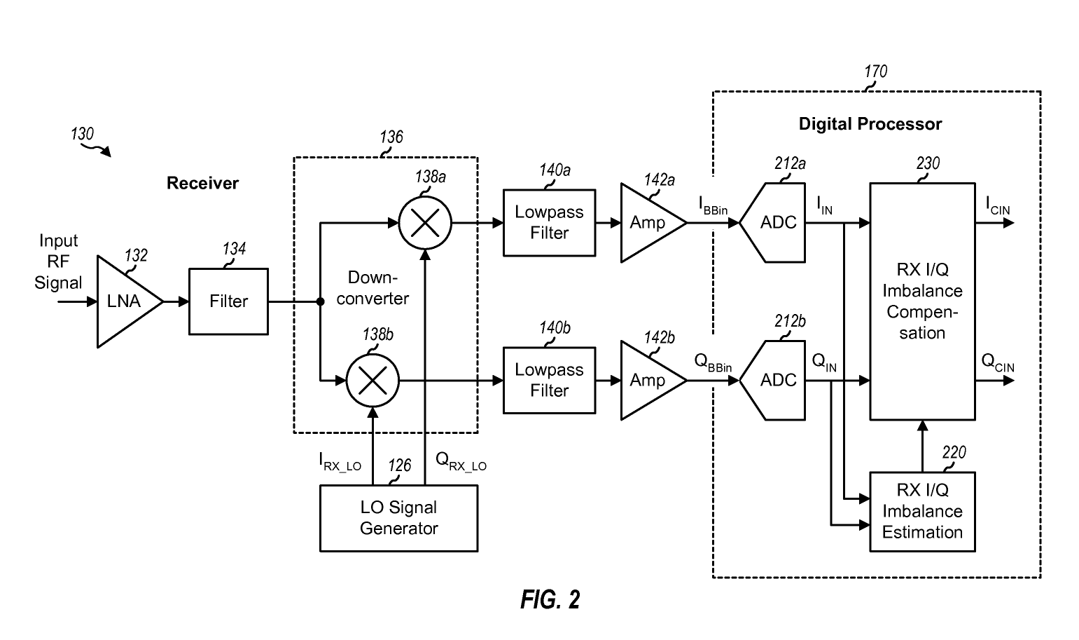

FIG. 2 shows a block diagram of an exemplary design of receiver 130 with circuitry for I/Q imbalance estimation and compensation. Receiver 130 may process the input RF signal and provide the I and Q input baseband signals to digital processor 170, as described above for FIG. 1.

Within digital processor 170, analog-to-digital converters (ADC) 212a and 212b receive and digitize the I and Q input baseband signals and provide I and Q input samples (I_{IN} and Q_{IN}), respectively. An RX I/Q imbalance estimation unit 220 receives the I and Q input samples and estimates I/Q imbalances between the I and Q branches of receiver 130, as described below. An RX I/Q imbalance compensation unit 230 also receives the I and Q input samples and the measured I/Q imbalances from estimation unit 220. Compensation unit 230 processes the I and Q input samples to compensate for I/Q imbalances between the I and Q branches, as described below, and provides I and Q compensated input samples (I_{CIN} and Q_{CIN}). The I and Q compensated input samples may be further processed (e.g., filtered, demodulated, decoded, etc.) to recover data sent in the input RF signal. Although not shown in FIG. 2, estimation unit 220 may also receive the I and Q compensated input samples from compensation unit 230 and may then be able to detect errors in I and Q compensation.

In an exemplary design, I/Q imbalances in receiver 130 (and also I/Q imbalances in transmitter 150) may be decomposed into (i) frequency-independent I/Q imbalance that is applicable across frequency and (ii) frequency-dependent I/Q imbalances that may vary across frequency. The frequency-independent and frequency-dependent I/Q imbalances may be estimated and compensated as described below.

In a first exemplary design of estimating I/Q imbalances in receiver 130, a continuous wave (CW) signal may be applied as the input RF signal. A CW signal is a periodic signal at a single frequency (ideally) but may include other spectral components (e.g., harmonics). The CW signal may be swept across frequency. In one design, the CW signal may be generated with a PLL and injected into receiver 130 via a switch. In another design, the CW signal may be provided by transmitter 150 via a loopback switch. In any case, I/Q imbalances in receiver 130 may be determined by examining the I and Q input samples from ADCs 212.

The CW signal may be expressed in discrete time as:

$${r}_{k} ( n ) = cos ( 2 π \frac{{f}_{in , k}}{{f}_{samp}} n ) , \qquad Eq ( 1 )$$

where n is a sample index,

k is a frequency index, which may also be referred to as a tone index,

f_{in,k} is the frequency of the CW signal for tone k,

fₛₐₘₚ is the sampling rate of ADCs 212, and
rₖ(n) denotes a sample of the CW signal for tone k at sample index n.

Ideal I and Q RX LO signals may be expressed in discrete time as:

$$c ( n ) = cos ( 2 π \frac{{f}_{LO}}{{f}_{samp}} n ) - j sin ( 2 π \frac{{f}_{LO}}{{f}_{samp}} n ) , \qquad Eq ( 2 )$$

where f_{LO} is the frequency of the I and Q RX LO signals, and

c(n) denotes a complex RX LO signal comprising the I and Q RX LO signals.

In an actual system, the CW signal and the LO signals are typically analog signals and are sampled after the signals are mixed and I/Q imbalances have affected the signals.

The I and Q RX LO signals may be set at a fixed frequency of f_{LO}, and the CW signal may be varied in frequency. The frequency of the I and Q input baseband signals may then be given as:

fₖ=f_{in,k}−f_{LO}, Eq (3)

where fₖ is the frequency of the I and Q input baseband signals corresponding to tone k.

The CW signal and the I and Q RX LO signals are typically not pure sinusoidal signals. Consequently, the I and Q input samples from ADCs 212 typically include odd harmonics such as 3rd and 5th harmonics. The I and Q input samples may be digitally filtered by estimation unit 220 to attenuate harmonics. The digitally filtered I and Q input samples may be used for I/Q imbalance estimation and may be referred to as simply I and Q samples.

For tone k, the I and Q samples used for I/Q imbalance estimation may be expressed as:

$$\begin{matrix}{x}_{I , k} ( n ) = LPF \{ \begin{matrix}{v}_{I , k} {e}^{- {jϕ}_{I , k}} cos ( 2 π \frac{{f}_{i n , k}}{{f}_{samp}} n ) \cdot \\ [ {γ}_{I} cos ( 2 π \frac{{f}_{LO}}{{f}_{samp}} n + {β}_{I} ) ]\end{matrix} \} , and & Eq ( 4 a ) \\ {x}_{Q , k} ( n ) = LPF \{ \begin{matrix}{v}_{Q , k} {e}^{- {jϕ}_{Q , k}} cos ( 2 π \frac{{f}_{i n , k}}{{f}_{samp}} n ) \cdot \\ [ - {γ}_{Q} sin ( 2 π \frac{{f}_{LO}}{{f}_{samp}} n + {β}_{Q} ) ]\end{matrix} \} , & Eq ( 4 b )\end{matrix}$$

where β₁ and β_{Q} denote the phase errors of the I and Q RX LO signals, respectively,
γ_{I} and γ_{Q} denote the gains of I mixer 138a and Q mixer 138b, respectively, as well as imbalance between the I and Q RX LO signals,
v_{I,k} denotes the gain and φ_{I,k} denotes the phase of the I branch at tone k,
v_{Q,k} denotes the gain and φ_{Q,k} denotes the phase of the Q branch at tone k,
x_{I,k} (n) denotes an I sample at sample index n for tone k,
x_{Q,k} (n) denotes a Q sample at sample index n for tone k, and
“LPF” denotes lowpass filtering performed on the I and Q samples.

In the exemplary design shown in equation set (4), I/Q imbalances in receiver 130 are approximated or modeled by a frequency-independent component and a frequency-dependent component. The frequency-independent component is modeled by phase errors β_{I} and β_{Q} and gain errors γ_{I} and γ_{Q} between the I and Q branches, which are not a function of tone k. The frequency-dependent component is modeled by gain v_{I,k} and phase φ_{I,k} for the I branch and gain v_{Q,k} and phase φ_{Q,k} for the Q branch, which are functions of tone k. The frequency-dependent component may include the effects of mixers 138, lowpass filters 140, amplifiers 142, and ADCs 212. The frequency responses of lowpass filters 140 may be a major contributor to the frequency-dependent component.

For each tone k, the root-mean-square (RMS) of the I and Q samples may be computed as follows:

$$\begin{matrix}{x}_{I , RMS} = \sqrt{\frac{1}{{N}_{k}} \cdot {\sum }_{n = 1}^{{N}_{k}} {[ {x}_{I , k} ( n ) ]}^{2}} = \frac{{v}_{I , k} {γ}_{I}}{2 \sqrt{2}} , and & Eq ( 5 a ) \\ {x}_{Q , RMS} = \sqrt{\frac{1}{{N}_{k}} \cdot {\sum }_{n = 1}^{{N}_{k}} {[ {x}_{Q , k} ( n ) ]}^{2}} = \frac{{v}_{Q , k} {γ}_{Q}}{2 \sqrt{2}} , & Eq ( 5 b )\end{matrix}$$

where Nₖ is the number of I and Q samples used to compute the RMS,

x_{I,RMS} denotes the RMS of the I samples for tone k, and

x_{Q,RMS} denotes the RMS of the Q samples for tone k.

The RMS should be computed for an integer number of cycles and for a sufficient number of cycles of a baseband CW signal at tone k in order to obtain a more accurate RMS measurement. Nₖ may be selected to include a sufficient number of samples for a sufficient integer number of cycles at tone k.

A gain imbalance g_{err,k} at tone k may be determined by taking the ratio of the RMS of the I and Q samples, as follows:

$${g}_{err , k} = \frac{{x}_{I , RMS}}{{x}_{Q , RMS}} = \frac{{v}_{I , k} {γ}_{I}}{{V}_{Q , k} {γ}_{Q}} . \qquad Eq ( 6 )$$

A phase error θ_{total,k} at tone k may be obtained by taking the arcsin of the average of the products of normalized I and Q samples, as follows:

$$\begin{matrix}{θ}_{total , k} = {sin}^{- 1} ( \frac{8}{{N}_{k}} \cdot {\sum }_{n = 1}^{{N}_{k}} \frac{{x}_{I , k} ( n )}{{v}_{I , k} {γ}_{I}} \cdot \frac{{x}_{Q , k} ( n )}{{v}_{Q , k} {γ}_{Q}} ) \\ = {sin}^{- 1} ( \frac{8}{{N}_{k} {v}_{I , k} {γ}_{I} {v}_{Q , k} {γ}_{Q}} \cdot {\sum }_{n = 1}^{{N}_{k}} {x}_{I , k} ( n ) \cdot {x}_{Q , k} ( n ) ) .\end{matrix} \qquad Eq ( 7 )$$

The gain imbalance g_{err,k} and the phase error θ_{total,k} may be determined for each of K different tones, where K may be any suitable value. The bandwidth of lowpass filters 140 may be dependent on the system bandwidth and may be denoted as f_{BW}. The K tones may be spaced uniformly across±the filter bandwidth or at specific frequencies by stepping the CW signal from f_{in,1}=f_{LO}−f_{BW} to f_{in,K}=f_{LO}+f_{BW}. The

K tones may be mirrored so that for each tone at a frequency of +fₓ there is a corresponding tone at a frequency of −fₓ.

The phase error θ_{total,k} for each tone k may be decomposed into (i) a frequency-independent phase error θ_{freq}_{_{—}}_{indep} that is applicable for all tones and (ii) a frequency-dependent phase error θₖ that is applicable for tone k. The frequency-independent phase error θ_{freq}_{_{—}}_{indep} may be obtained by averaging the phase errors of all K tones, as follows:

$${θ}_{freq\_indep} = \frac{1}{K} \cdot {\sum }_{k = 1}^{K} {θ}_{total , k} . \qquad Eq ( 8 )$$

The frequency-dependent phase error θₖ for each tone k may be expressed as:

θₖ=θ_{total,k}−θ_{freq}_{_{—}}_{indep}. Eq (9)

The I/Q imbalance at each tone k may then be expressed as:

Hₖ=g_{err,k}·e^{jθ}^{ₖ}, Eq (10)

where Hₖ denotes the complex I/Q imbalance at tone k. Frequency independent gain imbalance is included in g_{err,k} and does not need to be decomposed and compensated separately.

In a second exemplary design of estimating I/Q imbalances in receiver 130, the input RF signal may be used directly to estimate I/Q imbalances. This design may avoid the need to generate and inject a CW signal as the input RF signal. This design may also enable I/Q imbalance estimation without the need for a preamble in the input RF signal.

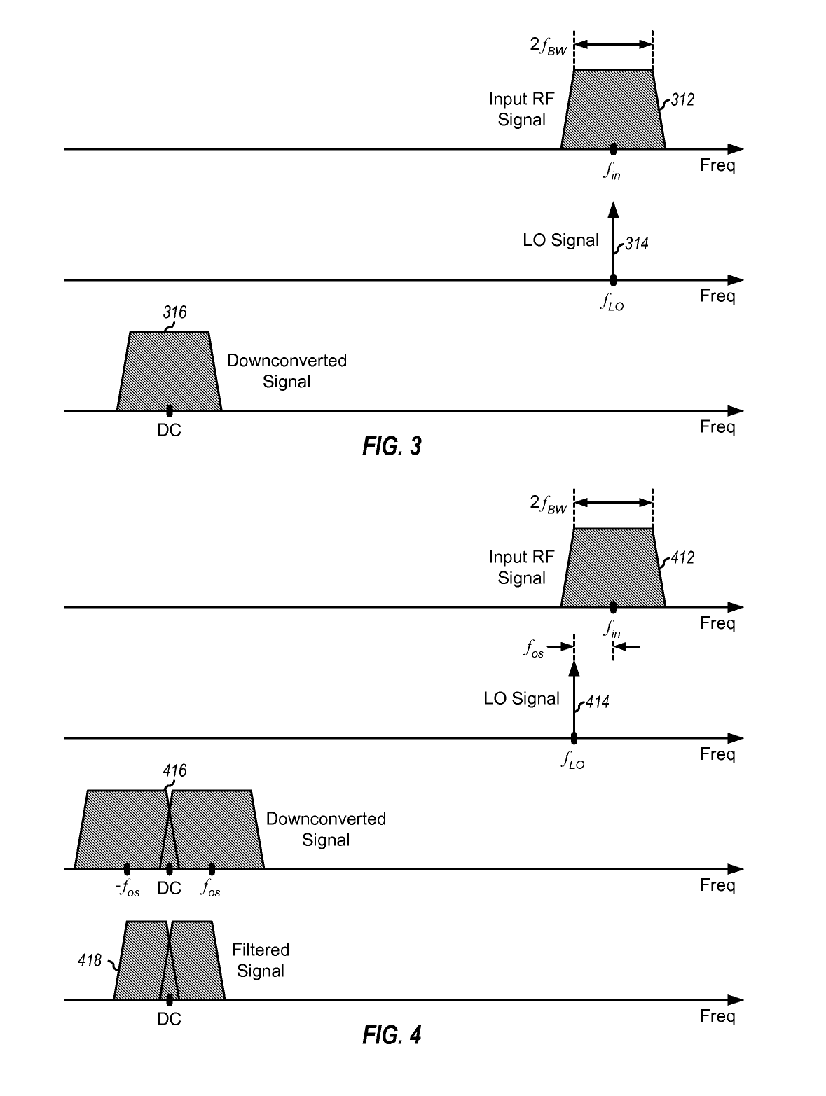

FIG. 3 shows downconversion of the input RF signal during normal operation. The input RF signal includes a desired signal 312 centered at a frequency of fᵢₙ and having a two-sided bandwidth of 2f_{BW}. The desired signal may have a relatively flat spectral response (as shown in FIG. 3) or a non-flat spectral response (e.g., due to signal properties or fading). The input RF signal may be downconverted with an RX LO signal 314 at a frequency of f_{LO}=fᵢₙ to obtain a downconverted signal 316 centered at DC and having a one-sided bandwidth of f_{BW}. The downconverted signal may be processed as described above.

FIG. 4 shows downconversion of the input RF signal for I/Q imbalance estimation. The input RF signal includes a desired signal 412 centered at a frequency of fᵢₙ and having a two-sided bandwidth of 2f_{BW}. The input RF signal may be downconverted with an RX LO signal 414 at a frequency of f_{LO}=fᵢₙ−fₒₛ to obtain a downconverted signal 416 centered at a frequency of +fₒₛ and having an image at a frequency of −fₒₛ. The downconverted signal may be filtered by lowpass filter 140 to obtain a filtered signal 418. The filtered signal may be processed to estimate I/Q imbalances.

As shown in FIG. 4, the frequency of the RX LO signal may be offset from the center frequency of the input RF signal, so that f_{LO}=fᵢₙ−fₒₛ. The frequency offset fₒₛ may be equal to f_{BW} or some other suitable value. The input RF signal may be a spread spectrum signal, e.g., as shown in FIGS. 3 and 4, instead of a CW signal.

The I and Q input samples from ADCs 212, with the I and Q RX LO signals being offset from the input RF signal, may be digitally filtered by estimation unit 220 with a Hamming window, a Hanning window, a Kaiser-Bessel window, a Gaussian window, or some other window. The window may attenuate side lobes resulting from the signal being “chopped” in the time domain into blocks of samples for subsequent processing. The digitally filtered I and Q input samples may be referred to as simply I and Q samples and may be expressed as:

$$\begin{matrix}{y}_{I} ( n ) = [ ( {γ}_{I} r ( n ) \cdot cos ( 2 π \frac{{f}_{LO}}{{f}_{samp}} n + {β}_{I} ) ] ⊗ {h}_{I} ( m ) , and & Eq ( 11 a ) \\ {y}_{Q} ( n ) = [ ( {γ}_{Q} r ( n ) \cdot sin ( 2 π \frac{{f}_{LO}}{{f}_{samp}} n + {β}_{Q} ) ] ⊗ {h}_{Q} ( m ) , & Eq ( 11 b )\end{matrix}$$

where r(n) denotes the input RF signal,

h_{I}(m) denotes the impulse response of the I branch of receiver 130,

h_{Q}(m) denotes the impulse response of the Q branch of receiver 130,

y_{I}(n) denotes an I sample at sample index n,

y_{Q}(n) denotes a Q sample at sample index n, and

[symbol] denotes a convolution operation.

Equation set (11) assumes that there is no side lobe, i.e., the signal has a sharp cutoff.

The I samples may be transformed to the frequency domain with an N-point fast Fourier transform (FFT) to obtain I symbols for N frequency bins (or simply, bins). Similarly, the Q samples may be transformed with an N-point FFT to obtain Q symbols for N frequency bins. The I samples have real values whereas the I symbols have complex values. Similarly, the Q samples have real values whereas the Q symbols have complex values. For clarity, in much of the description herein, a sample refers to a time-domain value whereas a symbol refers to a frequency-domain value. N may be selected to obtain the desired frequency resolution and may be equal to 128, 256, 512, 1024, 2048, etc. The I and Q symbols may be expressed as:

$$\begin{matrix}{Y}_{I} ( k ) = \frac{1}{2} {γ}_{I} {ν}_{I} ( k ) {e}^{{jϕ}_{I} ( k )} \cdot \{ {e}^{{jβ}_{I}} [ R ( k + {k}_{os} ) + R ( k - {k}_{os} ) ] \} , and & Eq ( 12 a ) \\ {Y}_{Q} ( k ) = - j \frac{1}{2} {γ}_{Q} {ν}_{Q} ( k ) {e}^{{jϕ}_{Q} ( k )} \cdot \{ {e}^{{jβ}_{Q}} [ R ( k + {k}_{os} ) + R ( k - {k}_{os} ) ] \} , & Eq ( 12 b )\end{matrix}$$

where γ_{I}, γ_{Q}, β_{I} and β_{Q} are described above,

v_{I}(k) denotes the gain and φ_{I}(k) denotes the phase of the I branch at bin k,

v_{Q}(k) denotes the gain and φ_{Q}(k) denotes the phase of the Q branch at bin k,

R(k±kₒₛ) denotes the RF signal at bin k±kₒₛ,

kₒₛ denotes the bin corresponding to the RX LO frequency offset fₒₛ,

Y_{I}(k) denotes an I symbol for bin k, and

Y_{Q}(k) denotes a Q symbol for bin k.

A gain imbalance g_{err,os}(k) for bin k with frequency offset fₒₛ may be determined by taking the ratio of the magnitudes of the I and Q symbols for bin k, as follows:

$${g}_{err , os} ( k ) = \frac{\vert {Y}_{1} ( k ) \vert}{\vert {Y}_{Q} ( k ) \vert} = \frac{{γ}_{I} {ν}_{I} ( k )}{{γ}_{Q} {ν}_{Q} ( k )} . \qquad Eq ( 13 )$$

A phase error θ_{total,os}(k) for bin k with LO frequency offset fₒₛ may be obtained by taking the difference of the angles of the I and Q symbols for bin k, as follows:

$$\begin{matrix}{θ}_{total , os} ( k ) = {∠Y}_{I} ( k ) - {∠Y}_{Q} ( k ) \\ = {tan}^{- 1} ( \frac{Im \{ {Y}_{I} ( k ) \}}{Re \{ {Y}_{I} ( k ) \}} ) - {tan}^{- 1} ( \frac{Im \{ {Y}_{Q} ( k ) \}}{Re \{ {Y}_{Q} ( k ) \}} ) ,\end{matrix} \qquad Eq ( 14 )$$

where Re{ } denotes the real part and Im{ } denotes the imaginary part.

For the second exemplary design, the frequency of the I and Q RX LO signals may be offset below the center frequency of the input RF signal and may be given as f_{LO}=fᵢₙ−fₒₛ. I and Q samples obtained with low-side frequency offset may be processed as described above to obtain gain imbalance g_{err,low}(k) and phase error θ_{total,low}(k) for each bin k within a frequency range of interest. This frequency range may correspond to±the filter bandwidth f_{BW}.

The frequency of the I and Q RX LO signals may also be offset above the center frequency of the input RF signal and may be given as f_{LO}=fᵢₙ+fₒₛ. I and Q samples obtained with high-side frequency offset may be processed as described above to obtain gain imbalance g_{err,high}(k) g_{err,high}(k) and phase error θ_{total,high}(k) for each bin k within the frequency range of interest.

A gain imbalance gₑᵣᵣ(k) for bin k may be determined by averaging the gain imbalances for the low-side and high-side frequency offsets, as follows:

$${g}_{err} ( k ) = \frac{{g}_{err , low} ( k ) + {g}_{err , high} ( k )}{2} . \qquad Eq ( 15 )$$

A phase error θₜₒₜₐₗ(k) for bin k may be obtained as follows:

$${θ}_{total} ( k ) = \{ \begin{matrix}{θ}_{total , low} ( k ) & for bin k corresponding to + {f}_{BW} \\ {θ}_{total , high} ( k ) & for bin k corresponding to - {f}_{BW} .\end{matrix} \qquad Eq ( 16 )$$

The phase error θₜₒₜₐₗ(k) may be offset by ±π/2.

The gain imbalance gₑᵣᵣ(k) and the phase error θₜₒₜₐₗ(k) may be determined for each of K different bins within the frequency range of interest, where K may be any suitable value. K may be dependent on the sampling rate fₛₐₘₚ, the filter bandwidth f_{BW}, the FFT size N, etc. The K bins may also cover mirrored±frequencies, as described above.

The phase error θₜₒₜₐₗ(k) for each bin k may be decomposed into (i) a frequency-independent phase error θ_{freq}_{_{—}}_{indep} that is applicable for all bins and (ii) a frequency-dependent phase error θ(k) that is applicable for bin k. The frequency-independent phase error θ_{freq}_{_{—}}_{indep} may be obtained by averaging the phase errors of all K bins, as follows:

$${θ}_{freq\_indep} = \frac{1}{K} \cdot {\sum }_{k = 1}^{K} {θ}_{total} ( k ) . \qquad Eq ( 17 )$$

The frequency-dependent phase error θ(k) for each bin k may be expressed as:

θ(k)=θₜₒₜₐₗ(k)−θ_{freq}_{_{—}}_{indep}. Eq (18)

The I/Q imbalance at each bin k may then be expressed as:

H(k)=gₑᵣᵣ(k)·e^{jθ(k)}, Eq (19)

where H(k) denotes the complex I/Q imbalance for bin k.

To improve accuracy of I/Q imbalance estimation, the I/Q imbalance may be estimated as described above based on a set of I and Q samples. The process may be repeated for one or more additional sets of I and Q samples. The I/Q imbalance estimates obtained with different sets of I and Q samples may be averaged to obtain a final I/Q imbalance estimate having better accuracy.

In one exemplary design of compensating for I/Q imbalances in receiver 130, a digital filter may be used to compensate for frequency-dependent I/Q imbalances between the I and Q branches of receiver 130. The digital filter may be a finite impulse response (FIR) filter, an infinite impulse response (IIR) filter, some other types of filter, or a combination thereof. Multipliers with scalars may be used to compensate for frequency-independent I/Q imbalances between the I and Q branches of receiver 130.

In one exemplary design, an L-tap FIR filter may be used to compensate for frequency-dependent I/Q imbalances, where L may be equal to 3, 4, 5, 6, 7, 8, 9 or some other suitable value. The number of taps (L) may be selected based on frequency variation of I/Q imbalance and the desired accuracy in I/Q imbalance compensation. The L coefficients of the FIR filter may be determined by finding the least squares best-fit for the measured I/Q imbalance. For clarity, the description below is for determining the coefficients of the FIR filter for the measured I/Q imbalance Hₖ, for k=0, . . . , K−1, for the first exemplary design.

A K×L matrix F may be defined as follows:

$$F = [ \begin{matrix}1 & {e}^{- {jτ}_{1} {ω}_{0}} & … & {e}^{- {jτ}_{L - 1} {ω}_{0}} \\ 1 & {e}^{- {jτ}_{1} {ω}_{1}} & … & {e}^{- {jτ}_{L - 1} {ω}_{1}} \\ ⋮ & ⋮ & ⋱ & ⋮ \\ 1 & {e}^{- {jτ}_{1} {ω}_{K - 1}} & … & {e}^{- {jτ}_{L - 1} {ω}_{K - 1}}\end{matrix} ] , \qquad Eq ( 20 )$$

where τₗ=l·τ and τ is one sample period for the FIR filter, for l=0, . . . , L−1, and

ωₖ is the frequency corresponding to tone k or bin k, for k=0, . . . , K−1.

The L coefficients for the FIR filter may then be determined as follows:

$$[ \begin{matrix}{a}_{0} \\ {a}_{1} \\ ⋮ \\ {α}_{L - 1}\end{matrix} ] = {F}^{- 1} \cdot [ \begin{matrix}{H}_{0} \\ {H}_{1} \\ ⋮ \\ {H}_{K - 1}\end{matrix} ] , \qquad Eq ( 21 )$$

where αₗ is the coefficient for the l-th tap of the FIR filter.

The FIR filter may be applied to either the I branch or the Q branch of receiver 130, depending on how the gain imbalances are computed. In particular, the FIR filter may be applied to the Q branch if the gain imbalances are computed based on x_{I,RMS}/x_{Q,RMS} or |Y_{I}(k)|/|Y_{Q}(k)|, as described above. The FIR filter may be applied to the I branch if the gain imbalances are computed based on x_{Q,RMS}/x_{I,RMS} or |Y_{Q}(k)|/|Y_{I}(k)|. The phase may be flipped depending on which branch is used as the reference.

In an exemplary design, a scalar c to compensate for frequency-independent I/Q imbalance may be determined as follows:

$$c = tan ( \frac{{θ}_{freq\_indep}}{2} ) . \qquad Eq ( 22 )$$

L coefficients of a FIR filter for the measured I/Q imbalance H(k), for k=0, . . . , K−1, for the second exemplary design may be determined in similar manner. In this case, the vector in the right hand side of equation (21) may be replaced with H(0) through H(K−1). The computation shown in equation (21) may then be performed to obtain the coefficients of the FIR filter for the second exemplary design.

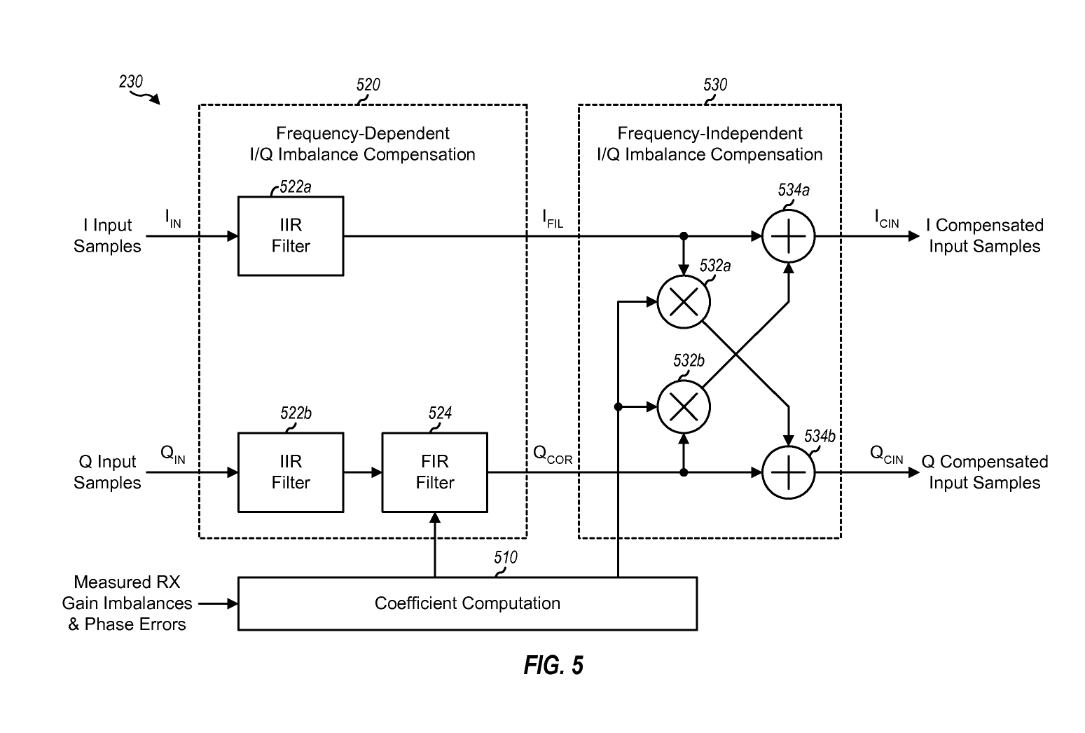

FIG. 5 shows an exemplary design of RX I/Q imbalance compensation unit 230 for receiver 130 in FIG. 2. Within compensation unit 230, a coefficient computation unit 510 receives the measured gain imbalances and phase errors and determines coefficients for a FIR filter to compensate for frequency-dependent I/Q imbalances between the I and Q branches, e.g., as shown in equation (21). Computation unit 510 also determines the scalar c used to compensate for frequency-independent I/Q imbalance between the I and Q branches, e.g., as shown in equation (22).

In the exemplary design shown in FIG. 5, compensation unit 230 includes a frequency-dependent I/Q imbalance compensation unit 520 and a frequency-independent I/Q imbalance compensation unit 530. Within compensation unit 520, an IIR filter 522a receives and filters the I input samples from ADC 212a in FIG. 2 and provides I filtered samples (I_{FIL}). An identical IIR filter 522b receives and filters the Q input samples from ADC 212b in FIG. 2 and provides Q filtered samples. IIR filters 522a and 522b may be used to ensure stability and may be referred to as noise reduction filters, “band-down” filters, etc. IIR filters 522a and 522b may be Butterworth filters or some other types of filter. IIR filters 522a and 522b may have a wider bandwidth than lowpass filters 140a and 140b in FIG. 2 (e.g., a bandwidth of approximately 1.5f_{BW}) in order to reduce impact to the overall response of the I and Q branches. A FIR filter 524 receives and filters the Q filtered samples from IIR filter 522b and provides Q corrected samples (Q_{COR}). FIR filter 524 compensates for frequency-dependent I/Q imbalances. FIR filter 524 may also be placed in the I branch instead of the Q branch, depending on how the I/Q imbalances were estimated.

Within compensation unit 530, a multiplier 532a multiplies the I filtered samples with scalar c and provides scaled I filtered samples. A multiplier 532b multiplies the Q corrected samples with scalar c and provides scaled Q corrected samples. A summer 534a sums the I filtered samples with the scaled Q corrected samples and provides I compensated input samples (I_{CIN}). A summer 534b sums the Q corrected samples with the scaled I filtered samples and provides Q compensated input samples (Q_{CIN}).

I/Q imbalance may be estimated once or periodically in order to track variation over time. I/Q imbalance may be compensated continuously.

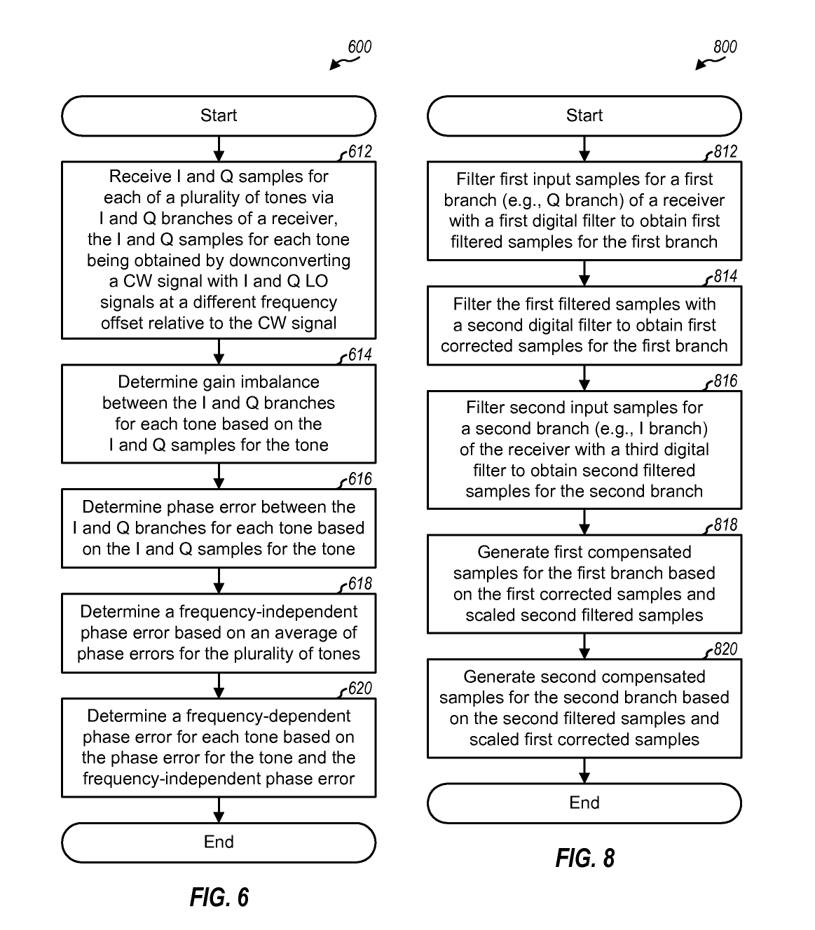

FIG. 6 shows an exemplary design of a process 600 for estimating I/Q imbalances in a receiver based on the first exemplary design described above. I and Q samples for each of a plurality of tones may be obtained via I and Q branches, respectively, of the receiver (block 612). The I and Q samples for each tone may be obtained by downconverting a CW signal with I and Q LO signals at a different frequency offset relative to the CW signal. In one exemplary design, the I and Q samples for each tone may be obtained by downconverting the CW signal at a different frequency with the I and Q LO signals at a fixed frequency. In another exemplary design, the I and Q samples for each tone may be obtained by downconverting the CW signal at a fixed frequency with the I and Q LO signals at a different frequency. The plurality of tones may thus be obtained by sweeping the CW signal or the I and Q LO signals across frequency. The I and Q samples may be obtained for a sufficient number of cycles of each tone.

Gain imbalance between the I and Q branches for each tone may be determined based on the I and Q samples for the tone (block 614). In one exemplary design, the gain imbalance between the I and Q branches for each tone may be determined based on a ratio of an RMS of the I samples for the tone and an RMS of the Q samples for the tone, e.g., as shown in equation (6). The phase error between the I and Q branches for each tone may be determined based on the I and Q samples for the tone (block 616). In one exemplary design, the phase error for each tone may be determined based on an average of the products of normalized I samples and normalized Q samples for the tone, e.g., as shown in equation (7).

A frequency-independent phase error may be determined based on an average of the phase errors for the plurality of tones, e.g., as shown in equation (8) (block 618). A frequency-dependent phase error for each tone may be determined based on the phase error for the tone and the frequency-independent phase error, e.g., as shown in equation (9) (block 620).

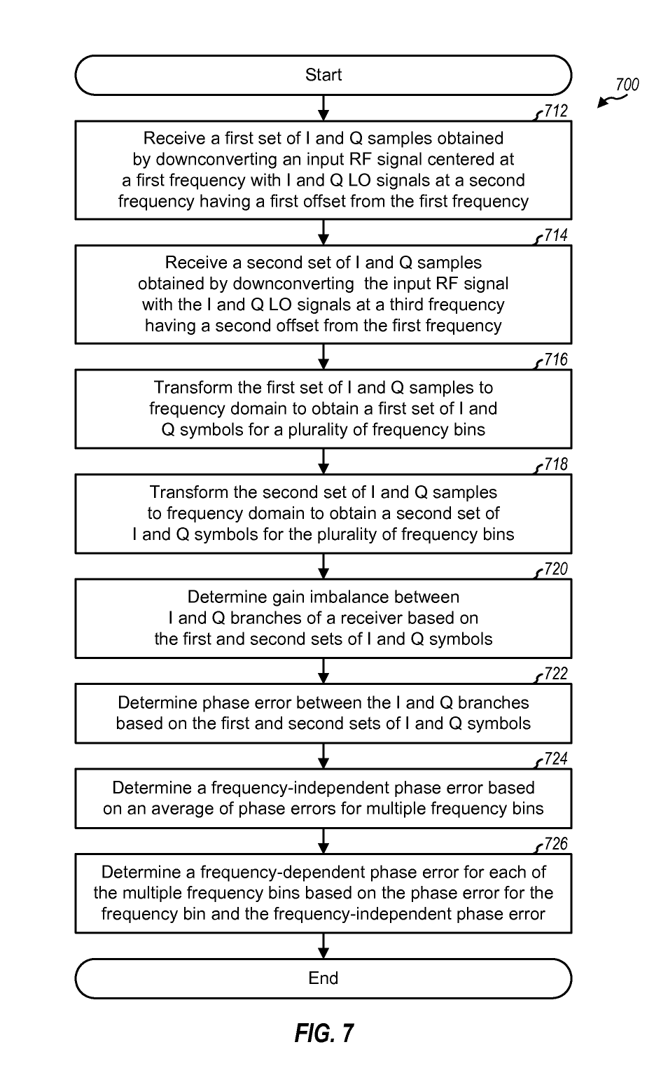

FIG. 7 shows an exemplary design of a process 700 for estimating I/Q imbalances in a receiver based on the second exemplary design described above. A first set of I and Q samples may be obtained by downconverting an input RF signal centered at a first frequency with I and Q LO signals at a second frequency (block 712). The second frequency may have a first offset from the first frequency. The I and Q samples may be obtained via I and Q branches, respectively, of the receiver. A second set of I and Q samples may be obtained by downconverting the input RF signal with the I and Q LO signals at a third frequency having a second offset from the first frequency (block 714). The first and second frequency offsets may have equal magnitude but opposite polarity. The magnitude of each frequency offset may be determined based on (e.g., equal to) the bandwidth of an analog filter in each of the I and Q branches.

The first set of I and Q samples may be transformed to the frequency domain to obtain a first set of I and Q symbols for a plurality of frequency bins (block 716). The second set of I and Q samples may also be transformed to the frequency domain to obtain a second set of I and Q symbols for the plurality of frequency bins (block 718).

Gain imbalance between the I and Q branches may be determined based on the first and second sets of I and Q symbols (block 720). In an exemplary design, gain imbalance between the I and Q branches for each of multiple frequency bins may be determined based on a ratio of the magnitude of an I symbol for the frequency bin to the magnitude of a Q symbol for the frequency bin, e.g., as shown in equation (13).

Phase error between the I and Q branches may be determined based on the first and second sets of I and Q symbols (block 722). In an exemplary design, the phase error between the I and Q branches for each of multiple frequency bins may be determined based on an angle of an I symbol for the frequency bin and an angle of a Q symbol for the frequency bin, e.g., as shown in equation (14). The phase error for each frequency bin corresponding to positive frequency may be determined based on I and Q symbols for that frequency bin in the first set of I and Q symbols, e.g., as shown in equation (16). The phase error for each frequency bin corresponding to negative frequency may be determined based on I and Q symbols for that frequency bin in the second set of I and Q symbols, e.g., as also shown in equation (16).

A frequency-independent phase error may be determined based on an average of phase errors for the multiple frequency bins (block 724). A frequency-dependent phase error for each of the multiple frequency bins may be determined based on the phase error for the frequency bin and the frequency-independent phase error (block 726).

FIG. 8 shows an exemplary design of a process 800 for compensating for I/Q imbalances in a receiver. First input samples (e.g., Q_{IN} in FIG. 5) for a first branch of the receiver may be filtered with a first digital filter (e.g., IIR filter 522b in FIG. 5) to obtain first filtered samples for the first branch (block 812). The first filtered samples may be filtered with a second digital filter (e.g., FIR filter 524) to obtain first corrected samples for the first branch (block 814). Second input samples (e.g., I_{IN} in FIG. 5) for a second branch of the receiver may be filtered with a third digital filter (e.g., IIR filter 522a) to obtain second filtered samples for the second branch (block 816). The first and second branches may correspond to Q and I branches, respectively, of the receiver if the compensating second digital filter is placed in the Q branch, as shown in FIG. 5. The first and second branches may also correspond to I and Q branches, respectively, if the compensating second digital filter is placed in the I branch.

The first and third digital filters may be of the same type (e.g., IIR filters) and may have the same frequency response. The second digital filter may be an FIR filter having a frequency response determined based on I/Q imbalances between the first and second branches of the receiver. The frequency response of the second digital filter may be determined based on gain imbalances and phase errors between the first and second branches for multiple frequencies, e.g., multiple tones or multiple frequency bins.

First compensated samples (e.g., Q_{CIN} in FIG. 5) for the first branch of the receiver may be generated based on the first corrected samples and scaled second filtered samples (block 818). Second compensated samples (e.g., I_{CIN} in FIG. 5) for the second branch of the receiver may be generated based on the second filtered samples and scaled first corrected samples (block 820). The first corrected samples may be scaled with a first scalar to obtain the scaled first corrected samples. The second filtered samples may be scaled with a second scalar to obtain the scaled second filtered samples. The first scalar may be equal to the second scalar.

The first corrected samples for the first branch and the second filtered samples for the second branch (e.g., Q_{COR} and I_{FIL} in FIG. 5) may be compensated for frequency-dependent I/Q imbalances between the first and second branches of the receiver. The first compensated samples for the first branch and the second compensated samples for the second branch (e.g., Q_{CIN} and I_{CIN} in FIG. 5) may be compensated for both frequency-dependent and frequency-independent I/Q imbalances between the first and second branches of the receiver.

Referring back to FIG. 1, transmitter 150 may have I/Q imbalances, which may result from (i) circuit blocks in the I branch (e.g., lowpass filter 152a, amplifier 154a, and mixer 158a) not matching circuit blocks in the Q branch (e.g., lowpass filter 152b, amplifier 154b, and mixer 158b) and (ii) mismatch of the I and Q TX LO signals. I/Q imbalances may degrade the performance of transmitter 150.

In another aspect, I/Q imbalances in transmitter 150 may be estimated and compensated in order to improve the performance of the transmitter. I/Q imbalances may be estimated for different frequencies to obtain frequency-dependent gain imbalances and phase errors between the I and Q branches of transmitter 150. I/Q imbalances may then be compensated across frequency, which may provide better performance than I/Q compensation at a single frequency.

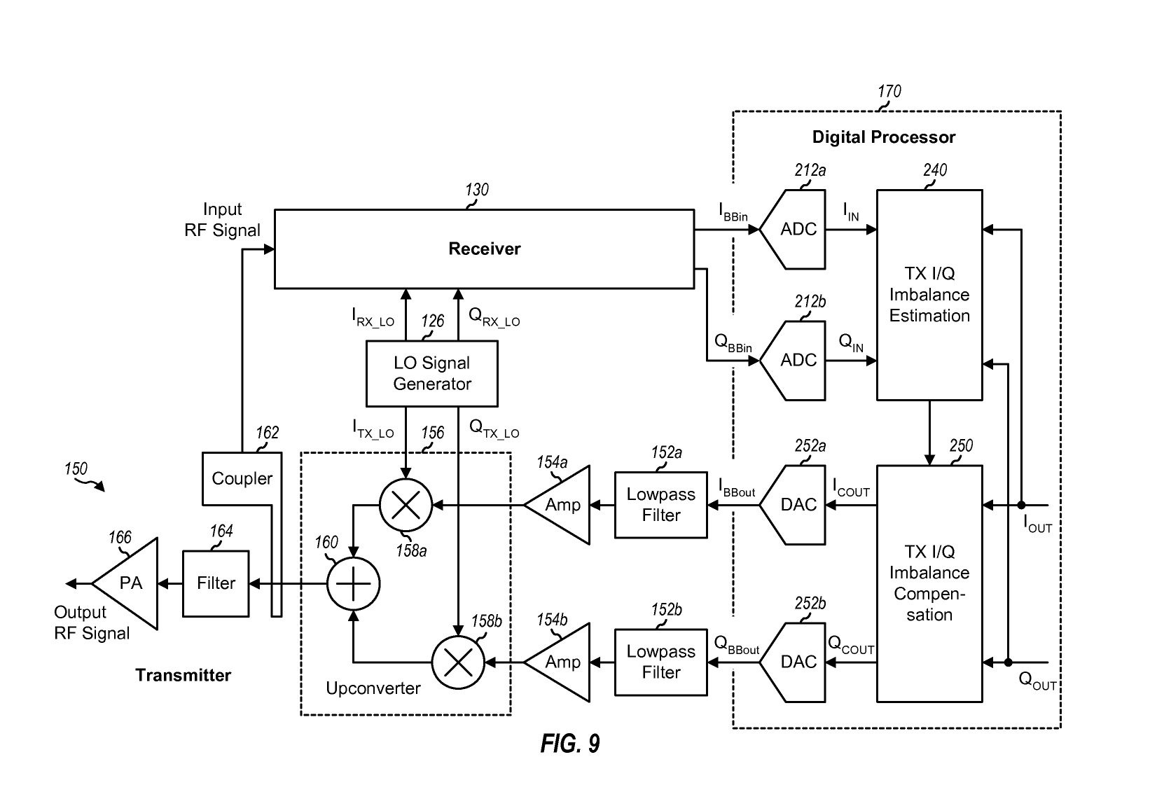

FIG. 9 shows a block diagram of an exemplary design of transmitter 150 with circuitry for I/Q imbalance estimation and compensation. Within digital processor 170, a TX I/Q imbalance compensation unit 250 receives and processes I and Q output samples (I_{OUT} and Q_{OUT}) to compensate for I/Q imbalances between the I and Q branches of transmitter 150, as described below, and provides I and Q compensated output samples (I_{COUT} and Q_{COUT}). Digital-to-analog converters (DACs) 252a and 252b convert the I and Q compensated output samples to analog and provide I and Q output baseband signals (I_{BBout} and Q_{BBout}), respectively. Transmitter 150 processes the I and Q output baseband signals and provides an output RF signal, as described above for FIG. 1.

In the exemplary design shown in FIG. 9, a coupler or switch 162 is placed between upconverter 156 and filter 164. Coupler/switch 162 may also be placed after filter 164 or after PA 166. Coupler/switch 162 provides a portion of the upconverted signal from upconverter 156 as the input RF signal to receiver 130. Receiver 130 processes the input RF signal and provides I and Q input baseband signals, as described above. LO signal generator 126 provides the I and Q TX LO signals to upconverter 156 within transmitter 150 as well as the I and Q RX LO signals to downconverter 136 within receiver 130. The TX LO signals and the RX LO signals are at the same frequency for TX I/Q imbalance estimation.

ADCs 212a and 212b digitize the I and Q input baseband signals and provide I and Q input samples, respectively. A TX I/Q imbalance estimation unit 240 receives the I and Q input samples and the I and Q output samples, estimates I/Q imbalances between the I and Q branches of transmitter 150 as described below, and provides frequency responses of the I and Q branches of transmitter 150. TX I/Q imbalance compensation unit 250 receives the frequency responses of the I and Q branches from estimation unit 220 and determines coefficients and scalars to compensate for I/Q imbalances in transmitter 150.

In a first exemplary design of estimating I/Q imbalances in transmitter 150, a reference signal may be applied as the I and Q output samples. The reference signal is a known signal and may be a pseudo-random noise signal, a signal having a constant envelop and a flat frequency response, etc. Receiver 130 and transmitter 150 may operate in a loopback configuration, as shown in FIG. 9. I/Q imbalances in transmitter 150 may then be determined by examining the I and Q input samples from ADCs 212. This exemplary design assumes that receiver 130 is calibrated and has negligible I/Q imbalances.

The I and Q input samples from ADCs 212 in the loopback configuration may be expressed as:

\hat{x}_{I}(n)=x_{I}(n) [symbol] h_{I}(m)+b·x_{Q}(n) [symbol] h_{Q}(m), and Eq (23a)

\hat{x}_{Q}(n)=x_{Q}(n) [symbol] h_{Q}(m)+a·x_{I}(n) [symbol] h_{I}(m), Eq (23b)

where x_{I}(n) and x_{Q}(n) denote the I and Q output samples, respectively,

h_{I}(m) denotes the impulse response of the I branch of transmitter 150,

h_{Q}(m) denotes the impulse response of the Q branch of transmitter 150,

a and b are scalars modeling frequency-independent I/Q phase imbalances, and

\hat{x}_{I}(n) and \hat{x}_{Q}(n) denote the I and Q input samples, respectively.

A block of N I input samples may be transformed to the frequency domain with an N-point FFT to obtain a block of N I input symbols for N bins. Similarly, a block of N Q input samples may be transformed with an N-point FFT to obtain a block of N Q input symbols for N frequency bins. The I and Q input symbols may be expressed as:

$$\begin{matrix}\begin{matrix}{\hat{X}}_{I} ( k ) = {X}_{I} ( k ) \cdot {H}_{I} ( k ) + b \cdot {X}_{Q} ( k ) \cdot {H}_{Q} ( k ) \\ = [ \begin{matrix}{X}_{I} ( k ) & {X}_{Q} ( k )\end{matrix} ] \cdot [ \begin{matrix}{H}_{I} ( k ) \\ b \cdot {H}_{Q} ( k )\end{matrix} ] ,\end{matrix} & Eq ( 24 a ) \\ \begin{matrix}{\hat{X}}_{Q} ( k ) = {X}_{Q} ( k ) \cdot {H}_{Q} ( k ) + a \cdot {X}_{I} ( k ) \cdot {H}_{I} ( k ) \\ = [ \begin{matrix}{X}_{I} ( k ) & {X}_{Q} ( k )\end{matrix} ] \cdot [ \begin{matrix}a \cdot {H}_{I} ( k ) \\ {H}_{Q} ( k )\end{matrix} ] ,\end{matrix} & Eq ( 24 b )\end{matrix}$$

where \hat{X}_{I}(k) and \hat{X}_{Q}(k) denote the FFTs of \hat{x}_{I}(n) and \hat{x}_{Q}(n), respectively,

H_{I}(k) and H_{Q}(k) denote the FFTs of h_{I}(m) and h_{Q}(m), respectively, and

X_{I}(k) and X_{Q}(k) denote the FFTs of x_{I}(n) and x_{Q}(n), respectively.

Multiple (R) blocks of I and Q input samples may be transformed to obtain R blocks of I and Q input symbols. For each bin k, the I input symbols in the R blocks may be stacked. For each bin k, the Q input symbols in the R blocks may also be stacked. The stacked I and Q symbols for each bin k may be expressed as:

$$\begin{matrix}[ \begin{matrix}{\hat{X}}_{I , 1} ( k ) \\ {\hat{X}}_{I , 2} ( k ) \\ ⋮ \\ {\hat{X}}_{I , R} ( k )\end{matrix} ] = [ \begin{matrix}{X}_{I , 1} ( k ) & {X}_{Q , 1} ( k ) \\ {X}_{I , 2} ( k ) & {X}_{Q , 2} ( k ) \\ ⋮ & ⋮ \\ {X}_{I , R} ( k ) & {X}_{Q , R} ( k )\end{matrix} ] \cdot [ \begin{matrix}{H}_{I} ( k ) \\ b \cdot {H}_{Q} ( k )\end{matrix} ] , and & Eq ( 25 a ) \\ [ \begin{matrix}{\hat{X}}_{Q , 1} ( k ) \\ {\hat{X}}_{Q , 2} ( k ) \\ ⋮ \\ {\hat{X}}_{Q , R} ( k )\end{matrix} ] = [ \begin{matrix}{X}_{I , 1} ( k ) & {X}_{Q , 1} ( k ) \\ {X}_{I , 2} ( k ) & {X}_{Q , 2} ( k ) \\ ⋮ & ⋮ \\ {X}_{I , R} ( k ) & {X}_{Q , R} ( k )\end{matrix} ] \cdot [ \begin{matrix}a \cdot {H}_{I} ( k ) \\ {H}_{Q} ( k )\end{matrix} ] , & Eq ( 25 b )\end{matrix}$$

where X_{I,r}(k) and X_{Q,r}(k) denote I and Q output symbols in the r-th block, and

\hat{X}_{I,r}(k) and \hat{X}_{Q,r}(k) denote I and Q input symbols in the r-th block.

In equation set (25), X_{I,r}(k) and X_{Q,r}(k) output symbols may be obtained from the known I and Q output samples x_{I}(n) and x_{Q}(n) provided to DACs 252 on the transmitter side. In particular, R blocks of I output samples may be transformed to obtain R blocks of I output symbols, and R blocks of Q output samples may be transformed to obtain R blocks of Q output symbols. The output samples may be reference output samples, arbitrary samples, transmit samples, etc. \hat{X}_{I,r}(k) and \hat{X}_{Q,r}(k) input symbols may be obtained from the I and Q input samples provided by ADCs 212 on the receiver side. Acquisition may be performed to time-align the I and Q input samples with the I and Q output samples.

The frequency responses of the I and Q branches of transmitter 150 for each bin k may be determined as follows:

$$\begin{matrix}[ \begin{matrix}{H}_{I} ( k ) \\ b \cdot {H}_{Q} ( k )\end{matrix} ] = {[ \begin{matrix}{X}_{I , 1} ( k ) & {X}_{Q , 1} ( k ) \\ {X}_{I , 2} ( k ) & {X}_{Q , 2} ( k ) \\ ⋮ & ⋮ \\ {X}_{I , R} ( k ) & {X}_{Q , R} ( k )\end{matrix} ]}^{- 1} \cdot [ \begin{matrix}{\hat{X}}_{I , 1} ( k ) \\ {\hat{X}}_{I , 2} ( k ) \\ ⋮ \\ {\hat{X}}_{I , R} ( k )\end{matrix} ] , and & Eq ( 26 a ) \\ [ \begin{matrix}a \cdot {H}_{I} ( k ) \\ {H}_{Q} ( k )\end{matrix} ] = {[ \begin{matrix}{X}_{I , 1} ( k ) & {X}_{Q , 1} ( k ) \\ {X}_{I , 2} ( k ) & {X}_{Q , 2} ( k ) \\ ⋮ & ⋮ \\ {X}_{I , R} ( k ) & {X}_{Q , R} ( k )\end{matrix} ]}^{- 1} \cdot [ \begin{matrix}{\hat{X}}_{Q , 1} ( k ) \\ {\hat{X}}_{Q , 2} ( k ) \\ ⋮ \\ {\hat{X}}_{Q , R} ( k )\end{matrix} ] . & Eq ( 26 b )\end{matrix}$$

Both H_{I}(k) and a·H_{I}(k) as well as H_{Q}(k) and b·H_{Q}(k) may be obtained from equation set (26). The scalars a and b may be determined as follows:

$$\begin{matrix}a = \frac{1}{K} \cdot {\sum }_{k = 1}^{K} Re \{ \frac{a \cdot {H}_{I} ( k )}{{H}_{I} ( k )} \} , and & Eq ( 27 ) \\ b = \frac{1}{K} \cdot {\sum }_{k = 1}^{K} Re \{ \frac{b \cdot {H}_{Q} ( k )}{{H}_{Q} ( k )} \} . & Eq ( 28 )\end{matrix}$$

In one exemplary design of compensating for I/Q imbalances in transmitter 150, separate FIR filters may be used to compensate for the frequency responses of the I and Q branches of transmitter 150. Multipliers with scalars may be used to compensate for frequency-independent I/Q imbalance between the I and Q branches of transmitter 150.

The coefficients for the FIR filters for the I and Q branches of transmitter 150 may be determined as follows:

$$\begin{matrix}[ \begin{matrix}{p}_{0} \\ {p}_{1} \\ ⋮ \\ {p}_{L - 1}\end{matrix} ] = {F}^{- 1} \cdot [ \begin{matrix}{H}_{I} ( 0 ) \\ {H}_{I} ( 1 ) \\ ⋮ \\ {H}_{1} ( K - 1 )\end{matrix} ] , and & Eq ( 29 a ) \\ [ \begin{matrix}{q}_{0} \\ {q}_{1} \\ ⋮ \\ {q}_{L - 1}\end{matrix} ] = {F}^{- 1} \cdot [ \begin{matrix}{H}_{Q} ( 0 ) \\ {H}_{Q} ( 1 ) \\ ⋮ \\ {H}_{Q} ( K - 1 )\end{matrix} ] , & Eq ( 29 b )\end{matrix}$$

where pₗ is the coefficient for the l-th tap of the FIR filter for the I branch, and

qₗ is the coefficient for the l-th tap of the FIR filter for the Q branch.

The FIR filters for the I and Q branches may have the same length or different lengths. The FIR filters for TX I/Q imbalance compensation may have the same or different lengths as the FIR filters for RX I/Q imbalance compensation.

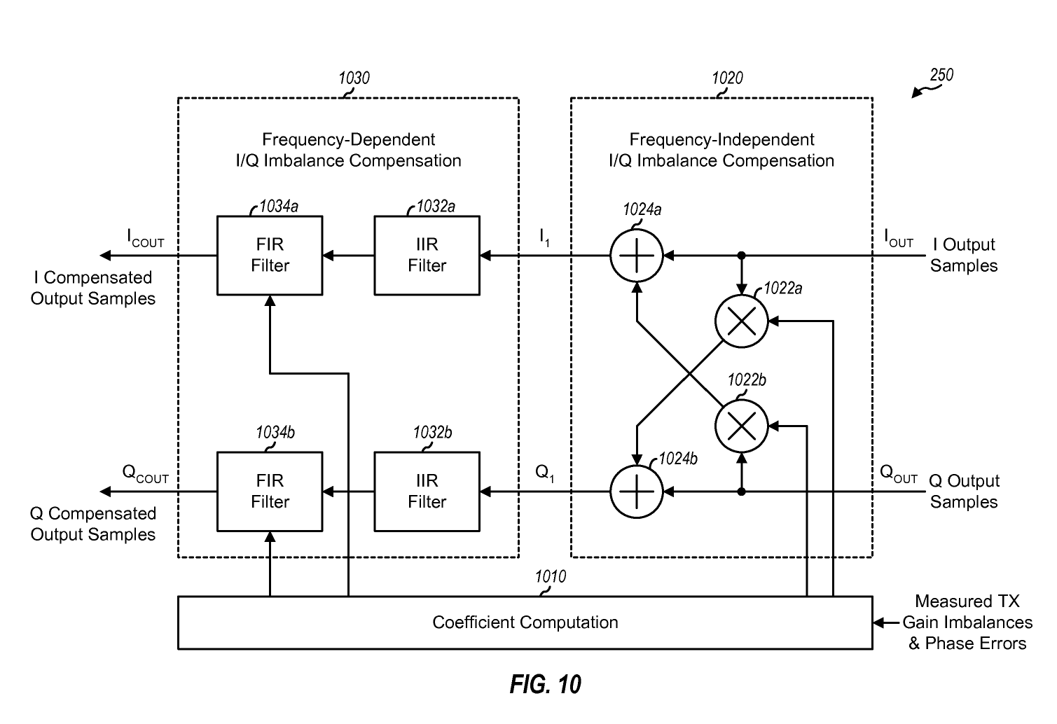

FIG. 10 shows an exemplary design of TX I/Q imbalance compensation unit 250 in FIG. 9. Within compensation unit 250, a coefficient computation unit 1010 receives the frequency responses H_{I}(k) and H_{Q}(k), which includes the gain imbalances and the frequency dependent phase errors between the I and Q branches of transmitter 150. Computation unit 1010 determines coefficients for a FIR filter 1034a for the I branch based on H_{I}(k) and also determines coefficients for a FIR filter 1034b for the Q branch based on H_{Q}(k), e.g., as shown in equation set (29).

In the exemplary design shown in FIG. 10, compensation unit 250 includes a frequency-independent I/Q imbalance compensation unit 1020 and a frequency-dependent I/Q imbalance compensation unit 1030. Within compensation unit 1020, a multiplier 1022a multiplies the I output samples with scalar a and provides scaled I output samples. A multiplier 1022b multiplies the Q output samples with scalar b and provides scaled Q output samples. A summer 1024a sums the I output samples with the scaled Q output samples and provides first I samples (I_{I}). A summer 1024b sums the Q output samples with the scaled I output samples and provides first Q samples (Q_{I}).

Within compensation unit 1030, an IIR filter 1032a receives and filters the first I samples. FIR filter 1034a further filters the output samples from IIR filter 1032a and provides I compensated output samples (I_{COUT}). An IIR filter 1032b receives and filters the first Q samples. FIR filter 1034b further filters the output samples from IIR filter 1032b and provides Q compensated output samples (Q_{COUT}). IIR filters 1032a and 1032b may be noise reduction filters having a wider bandwidth (e.g., 1.5 f_{BW}).

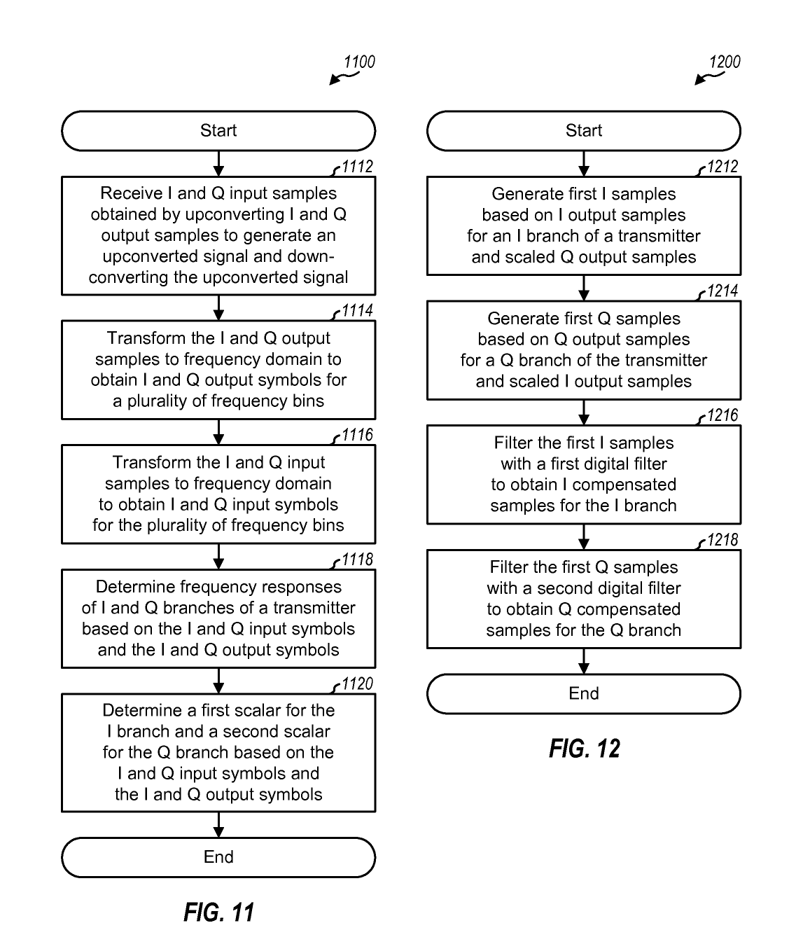

FIG. 11 shows an exemplary design of a process 1100 for estimating I/Q imbalances in a transmitter. I and Q input samples may be obtained by upconverting I and Q output samples to generate an upconverted signal and downconverting the upconverted signal (block 1112). The I and Q output samples may be provided via I and Q branches, respectively, of the transmitter. The I and Q output samples may be transformed to the frequency domain to obtain I and Q output symbols for a plurality of frequency bins (block 1114). The I and Q input samples may also be transformed to the frequency domain to obtain I and Q input symbols for the plurality of frequency bins (block 1116). In one exemplary design, the I and Q input samples may be partitioned into multiple blocks of I and Q input samples. Each block of I and Q input samples may be transformed to the frequency domain with an FFT to obtain a corresponding block of I and Q input symbols for the plurality of frequency bins.

Frequency responses of the I and Q branches of the transmitter may be determined based on the I and Q input symbols and the I and Q output symbols (block 1118). In one exemplary design, a first complex gain (e.g., H_{I}(k) and a·H_{I}(k)) for the I branch and a second complex gain (e.g., H_{Q}(k) and b·H_{Q}(k)) for the Q branch for each of multiple frequency bins may be determined based on I and Q input symbols for the frequency bin in the multiple blocks of I and Q input symbols, e.g., as shown in equation set (26). The frequency response of the I branch may comprise first complex gains for the I branch for the multiple frequency bins. The frequency response of the Q branch may comprise second complex gains for the Q branch for the multiple frequency bins. The frequency response may also comprise phase information for the I and Q branches. The frequency responses of the I and Q branches may be used to compensate for frequency-dependent I/Q imbalances between the I and Q branches of the transmitter.

A first scalar for the I branch and a second scalar for the Q branch may also be determined based on the I and Q input symbols and the I and Q output symbols (block 1120). The first and second scalars may be used to compensate for frequency-independent I/Q imbalance between the I and Q branches of the transmitter

FIG. 12 shows an exemplary design of a process 1200 for compensating for I/Q imbalances in a transmitter. First I samples for an I branch of the transmitter may be generated based on I output samples for the I branch and scaled Q output samples (block 1212). First Q samples for a Q branch of the transmitter may be generated based on Q output samples for the Q branch and scaled I output samples (block 1214). The I output samples may be scaled with a first scalar to obtain the scaled I output samples. The Q output samples may be scaled with a second scalar to obtain the scaled Q output samples. The first I and Q samples may be compensated for frequency-independent I/Q imbalance between the I and Q branches of the transmitter in this manner.

The first I samples for the I branch may be filtered with a first digital filter (e.g., FIR filter 1034a in FIG. 10) to obtain I compensated samples for the I branch (block 1216). The first Q samples for the Q branch may be filtered with a second digital filter (e.g., FIR filter 1034b) to obtain Q compensated samples for the Q branch (block 1218). The I and Q compensated samples may be compensated for both frequency-dependent and frequency-independent I/Q imbalances between the I and Q branches of the transmitter in this manner.

In one exemplary design, the frequency response of the I branch of the transmitter may be determined and used to determine the coefficients of the first digital filter. The frequency response of the Q branch of the transmitter may also be determined and used to determine the coefficients of the second digital filter. The frequency responses of the first and second digital filters may thus compensate for frequency-dependent I/Q imbalance between the I and Q branches of the transmitter. The first and second scalars may be selected to compensate for frequency-independent I/Q imbalance between the I and Q branches of the transmitter.

The I/Q imbalance estimation and compensation techniques described herein may be used to estimate and compensate for frequency-dependent I/Q imbalances, which may arise due to mismatched analog lowpass filters and other circuit blocks. The techniques may enable a receiver and a transmitter to achieve higher image rejection across an operating band, which may improve performance.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a DSP, an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but is to be accorded the widest scope consistent with the principles and novel features disclosed herein.

What is claimed is:

1. A method of determining inphase/quadrature (I/Q) imbalances in a receiver, comprising:
receiving I and Q samples for each of a plurality of tones via I and Q branches, respectively, of the receiver, the I and Q samples for each tone being obtained by downconverting a continuous wave (CW) signal with I and Q local oscillator (LO) signals at a different frequency offset relative to the CW signal;
determining gain imbalance between the I and Q branches for each tone based on the I and Q samples for the tone; and
determining phase error between the I and Q branches for each tone based on the I and Q samples for the tone.

2. The method of claim 1, the I and Q samples for each tone being obtained by downconverting the CW signal at a different frequency with the I and Q LO signals at a fixed frequency.

3. The method of claim 1, the determining gain imbalance between the I and Q branches for each tone comprising
determining the gain imbalance between the I and Q branches for each tone based on a ratio of a root-mean-square (RMS) of the I samples for the tone and an RMS of the Q samples for the tone.

4. The method of claim 1, the determining phase error between the I and Q branches for each tone comprising
determining the phase error for each tone based on an average of products of normalized I samples and normalized Q samples for the tone.

5. The method of claim 1, further comprising:
determining a frequency-independent phase error based on an average of phase errors for the plurality of tones; and
determining a frequency-dependent phase error for each tone based on the phase error for the tone and the frequency-independent phase error.

6. An apparatus comprising:
at least one processor to receive inphase (I) and quadrature (Q) samples for each of a plurality of tones via I and Q branches, respectively, of a receiver, the I and Q samples for each tone being obtained by downconverting a continuous wave (CW) signal with I and Q local oscillator (LO) signals at a different frequency offset relative to the CW signal, to determine gain imbalance between the I and Q branches for each tone based on the I and Q samples for the tone, and to determine phase error between the I and Q branches for each tone based on the I and Q samples for the tone.

7. The apparatus of claim 6, the at least one processor further determines the gain imbalance between the I and Q branches for each tone based on a ratio of a root-mean-square (RMS) of the I samples for the tone and an RMS of the Q samples for the tone.

8. The apparatus of claim 6, the at least one processor further determines the phase error for each tone based on an average of products of normalized I samples and normalized Q samples for the tone.

9. The apparatus of claim 6, the at least one processor further determines a frequency-independent phase error based on an average of phase errors for the plurality of tones, and determines a frequency-dependent phase error for each tone based on the phase error for the tone and the frequency-independent phase error.

10. A method of determining inphase/quadrature (I/Q) imbalances in a receiver, comprising:
receiving a first set of I and Q samples obtained by downconverting an input radio frequency (RF) signal centered at a first frequency with I and Q local oscillator (LO) signals at a second frequency, the second frequency having a first offset from the first frequency, the I and Q samples being obtained via I and Q branches, respectively, of the receiver;
transforming the first set of I and Q samples to frequency domain to obtain a first set of I and Q symbols for a plurality of frequency bins;
determining gain imbalance between the I and Q branches based on the first set of I and Q symbols; and
determining phase error between the I and Q branches based on the first set of I and Q symbols.

11. The method of claim 10, further comprising:
receiving a second set of I and Q samples obtained by downconverting the input RF signal centered at the first frequency with the I and Q LO signals at a third frequency, the third frequency having a second offset from the first frequency;
transforming the second set of I and Q samples to frequency domain to obtain a second set of I and Q symbols for the plurality of frequency bins;
determining the gain imbalance between the I and Q branches based further on the second set of I and Q symbols; and
determining the phase error between the I and Q branches based further on the second set of I and Q symbols.

12. The method of claim 11, the first and second offsets having equal magnitude but opposite polarity.

13. The method of claim 10, the I and Q branches each comprising an analog filter having a particular bandwidth, the first offset being determined based on the bandwidth of the analog filter or the input RF signal.

14. The method of claim 10, the determining gain imbalance between the I and Q branches comprising
determining gain imbalance between the I and Q branches for each of multiple frequency bins based on a ratio of magnitude of an I symbol for the frequency bin to magnitude of a Q symbol for the frequency bin.

15. The method of claim 10, the determining phase error between the I and Q branches comprising
determining phase error between the I and Q branches for each of multiple frequency bins based on an angle of an I symbol for the frequency bin and an angle of a Q symbol for the frequency bin.

16. The method of claim 15, the determining phase error between the I and Q branches further comprising
determining a frequency-independent phase error based on an average of phase errors for the multiple frequency bins, and
determining a frequency-dependent phase error for each of the multiple frequency bins based on the phase error for the frequency bin and the frequency-independent phase error.

17. The method of claim 11, the determining phase error between the I and Q branches comprising
determining phase error between the I and Q branches for each of multiple frequency bins corresponding to positive frequency based on an angle of a first I symbol for the frequency bin and an angle of a first Q symbol for the frequency bin, the first I symbol and the first Q symbol being from the first set of I and Q symbols, and
determining phase error between the I and Q branches for each of multiple frequency bins corresponding to negative frequency based on an angle of a second I symbol for the frequency bin and an angle of a second Q symbol for the frequency bin, the second I symbol and the second Q symbol being from the second set of I and Q symbols.

18. An apparatus comprising:
at least one processor to receive a set of inphase (I) and quadrature (Q) samples obtained by downconverting an input radio frequency (RF) signal centered at a first frequency with I and Q local oscillator (LO) signals at a second frequency, the second frequency having a first offset from the first frequency, the I and Q samples being obtained via I and Q branches, respectively, of a receiver, to transform the set of I and Q samples to frequency domain to obtain a set of I and Q symbols for a plurality of frequency bins, to determine gain imbalance between the I and Q branches based on the set of I and Q symbols, and to determine phase error between the I and Q branches based on the set of I and Q symbols.

19. The apparatus of claim 18, the at least one processor further determines gain imbalance between the I and Q branches for each of multiple frequency bins based on a ratio of magnitude of an I symbol for the frequency bin to magnitude of a Q symbol for the frequency bin.

20. The apparatus of claim 18, the at least one processor further determines phase error between the I and Q branches for each of multiple frequency bins based on an angle of an I symbol for the frequency bin and an angle of a Q symbol for the frequency bin.

21. The apparatus of claim 20, the at least one processor further determines a frequency-independent phase error based on an average of phase errors for the multiple frequency bins, and determines a frequency-dependent phase error for each of the multiple frequency bins based on the phase error for the frequency bin and the frequency-independent phase error.

22. An apparatus comprising:
means for receiving a set of inphase (I) and quadrature (Q) samples obtained by downconverting an input radio frequency (RF) signal centered at a first frequency with I and Q local oscillator (LO) signals at a second frequency, the second frequency having a first offset from the first frequency, the I and Q samples being obtained via I and Q branches, respectively, of a receiver;
means for transforming the set of I and Q samples to frequency domain to obtain a set of I and Q symbols for a plurality of frequency bins;
means for determining gain imbalance between the I and Q branches based on the set of I and Q symbols; and
means for determining phase error between the I and Q branches based on the set of I and Q symbols.

23. The apparatus of claim 22, the means for determining gain imbalance between the I and Q branches comprising
means for determining gain imbalance between the I and Q branches for each of multiple frequency bins based on a ratio of magnitude of an I symbol for the frequency bin to magnitude of a Q symbol for the frequency bin.

24. The apparatus of claim 22, the means for determining phase error between the I and Q branches comprising
means for determining phase error between the I and Q branches for each of multiple frequency bins based on an angle of an I symbol for the frequency bin and an angle of a Q symbol for the frequency bin.

25. The apparatus of claim 24, the means for determining phase error between the I and Q branches further comprising
means for determining a frequency-independent phase error based on an average of phase errors for the multiple frequency bins, and
means for determining a frequency-dependent phase error for each of the multiple frequency bins based on the phase error for the frequency bin and the frequency-independent phase error.

26. A computer program product, comprising:
a computer-readable medium comprising:
code for causing at least one computer to receive a set of inphase (I) and quadrature (Q) samples obtained by downconverting an input radio frequency (RF) signal centered at a first frequency with I and Q local oscillator (LO) signals at a second frequency, the second frequency having a first offset from the first frequency, the I and Q samples being obtained via I and Q branches, respectively, of a receiver,
code for causing the at least one computer to transform the set of I and Q samples to frequency domain to obtain a set of I and Q symbols for a plurality of frequency bins,
code for causing the at least one computer to determine gain imbalance between the I and Q branches based on the set of I and Q symbols, and
code for causing the at least one computer to determine phase error between the I and Q branches based on the set of I and Q symbols.

27. A method of compensating for inphase/quadrature (I/Q) imbalances in a receiver, comprising:
filtering first input samples for a first branch of the receiver with a first digital filter to obtain first filtered samples for the first branch;
filtering the first filtered samples with a second digital filter to obtain first corrected samples for the first branch; and
filtering second input samples for a second branch of the receiver with a third digital filter to obtain second filtered samples for the second branch, the first and second branches corresponding to I and Q branches, respectively, or to Q and I branches, respectively, of the receiver, and the first corrected samples for the first branch and the second filtered samples for the second branch being compensated for I/Q imbalances between the first and second branches of the receiver.

28. The method of claim 27, the first and third digital filters being of same type and having same frequency response.

29. The method of claim 27, the first and third digital filters comprising infinite impulse response (IIR) filters having same frequency response.

30. The method of claim 27, the second digital filter comprising a finite impulse response (FIR) filter having a frequency response determined based on I/Q imbalances between the first and second branches of the receiver.

31. The method of claim 27, further comprising:
determining gain imbalance and phase error between the first and second branches for each of multiple frequencies; and
determining frequency response of the second digital filter based on gain imbalances and phase errors between the first and second branches for the multiple frequencies.

32. The method of claim 27, further comprising:
generating first compensated samples for the first branch based on the first corrected samples and scaled second filtered samples; and
generating second compensated samples for the second branch based on the second filtered samples and scaled first corrected samples, the first corrected samples for the first branch and the second filtered samples for the second branch being compensated for frequency-dependent I/Q imbalances between the first and second branches of the receiver, and the first compensated samples for the first branch and the second compensated samples for the second branch being compensated for frequency-dependent and frequency-independent I/Q imbalances between the first and second branches of the receiver.

33. The method of claim 32, further comprising:
scaling the first corrected samples with a first scalar to obtain the scaled first corrected samples; and
scaling the second filtered samples with a second scalar to obtain the scaled second filtered samples, the first and second scalars being selected to compensate for frequency-independent I/Q imbalance between the first and second branches of the receiver.

34. An apparatus comprising:
at least one processor to filter first input samples for a first branch of a receiver with a first digital filter to obtain first filtered samples for the first branch, to filter the first filtered samples with a second digital filter to obtain first corrected samples for the first branch, and to filter second input samples for a second branch of the receiver with a third digital filter to obtain second filtered samples for the second branch, the first and second branches corresponding to inphase (I) and quadrature (Q) branches, respectively, or to Q and I branches, respectively, of the receiver, and the first corrected samples for the first branch and the second filtered samples for the second branch being compensated for I/Q imbalances between the first and second branches of the receiver.

35. The apparatus of claim 34, the at least one processor further determines gain imbalance and phase error between the first and second branches for each of multiple frequencies, and determines frequency response of the second digital filter based on gain imbalances and phase errors between the first and second branches for the multiple frequencies.

36. The apparatus of claim 34, the at least one processor further generates first compensated samples for the first branch based on the first corrected samples and scaled second filtered samples, and generates second compensated samples for the second branch based on the second filtered samples and scaled first corrected samples, the first corrected samples for the first branch and the second filtered samples for the second branch being compensated for frequency-dependent I/Q imbalances between the first and second branches of the receiver, and the first compensated samples for the first branch and the second compensated samples for the second branch being compensated for frequency-dependent and frequency-independent I/Q imbalances between the first and second branches of the receiver.

37. A method of determining inphase/quadrature (I/Q) imbalances of a transmitter, comprising:
receiving I and Q input samples obtained by upconverting I and Q output samples to generate an upconverted signal and downconverting the upconverted signal, the I and Q output samples being provided via I and Q branches, respectively, of the transmitter;
transforming the I and Q input samples to frequency domain to obtain I and Q input symbols for a plurality of frequency bins; and
determining frequency responses of the I and Q branches of the transmitter based on the I and Q input symbols.

38. The method of claim 37, further comprising:
transforming the I and Q output samples to frequency domain to obtain I and Q output symbols for the plurality of frequency bins, and
determining the frequency responses of the I and Q branches of the transmitter based further on the I and Q output symbols.

39. The method of claim 37, the transforming the I and Q input samples comprising
partitioning the I and Q input samples into multiple blocks of I and Q input samples, and
transforming each of the multiple blocks of I and Q input samples to frequency domain with a fast Fourier transform (FFT) to obtain a corresponding one of multiple blocks of I and Q input symbols for the plurality of frequency bins.

40. The method of claim 39, the determining frequency responses of the I and Q branches of the transmitter comprising
determining a first complex gain for the I branch and a second complex gain for the Q branch for each of multiple frequency bins based on I and Q input symbols for the frequency bin in the multiple blocks of I and Q input symbols,
obtaining the frequency response of the I branch comprising first complex gains for the I branch for the multiple frequency bins, and
obtaining the frequency response of the Q branch comprising second complex gains for the Q branch for the multiple frequency bins.

41. The method of claim 37, further comprising:
determining a first scalar for the I branch and a second scalar for the Q branch based on I and Q input symbols for multiple frequency bins in the multiple blocks of I and Q input symbols, the first and second scalars compensating for frequency-independent I/Q imbalance between the I and Q branches of the transmitter

42. An apparatus comprising:
at least one processor to receive inphase (I) and quadrature (Q) input samples obtained by upconverting I and Q output samples to generate an upconverted signal and downconverting the upconverted signal, the I and Q output samples being provided via I and Q branches, respectively, of a transmitter, to transform the I and Q input samples to frequency domain to obtain I and Q input symbols for a plurality of frequency bins, and to determine frequency responses of the I and Q branches of the transmitter based on the I and Q input symbols.

43. The apparatus of claim 42, the at least one processor further partitions the I and Q input samples into multiple blocks of I and Q input samples, and transforms each of the multiple blocks of I and Q input samples to frequency domain with a fast Fourier transform (FFT) to obtain a corresponding one of multiple blocks of I and Q input symbols for the plurality of frequency bins.

44. The apparatus of claim 42, the at least one processor further determines a first complex gain for the I branch and a second complex gain for the Q branch for each of multiple frequency bins based on I and Q input symbols for the frequency bin in the multiple blocks of I and Q input symbols, obtains the frequency response of the I branch comprising first complex gains for the I branch for the multiple frequency bins, and obtains the frequency response of the Q branch comprising second complex gains for the Q branch for the multiple frequency bins.

45. The apparatus of claim 42, the at least one processor further determines a first scalar for the I branch and a second scalar for the Q branch based on I and Q input symbols for multiple frequency bins in the multiple blocks of I and Q input symbols, and applies the first and second scalars to compensate for frequency-independent I/Q imbalance between the I and Q branches of the transmitter

46. A method of compensating for inphase/quadrature (I/Q) imbalances in a transmitter, comprising:
filtering first I samples for an I branch of the transmitter with a first digital filter to obtain I compensated samples; and
filtering first Q samples for a Q branch of the transmitter with a second digital filter to obtain Q compensated samples, the I and Q compensated samples being compensated for I/Q imbalances between the I and Q branches of the transmitter at multiple frequencies.

47. The method of claim 46, further comprising:
generating the first I samples based on I output samples for the I branch and scaled Q output samples; and
generating the first Q samples based on Q output samples for the Q branch and scaled I output samples, the first I and Q samples being compensated for frequency-independent I/Q imbalance between the I and Q branches of the transmitter, and the I and Q compensated samples being compensated for frequency-dependent and frequency-independent I/Q imbalances between the I and Q branches of the transmitter.

48. The method of claim 47, further comprising:
scaling the I output samples with a first scalar to obtain the scaled I output samples; and
scaling the Q output samples with a second scalar to obtain the scaled Q output samples, the first and second scalars being selected to compensate for frequency-independent I/Q imbalance between the I and Q branches of the transmitter.

49. The method of claim 46, further comprising:
obtaining frequency response of the I branch of the transmitter;
obtaining frequency response of the Q branch of the transmitter;
determining coefficients of the first digital filter based on the frequency response of the I branch; and
determining coefficients of the second digital filter based on the frequency response of the Q branch.

50. The method of claim 46, the first and second digital filters comprising finite impulse response (FIR) filters having multiple taps.

51. The method of claim 46, the filtering the first I samples comprises filtering the first I samples further with a third digital filter to obtain the I compensated samples, and the filtering the first Q samples comprises filtering the first Q samples further with a fourth digital filter to obtain the Q compensated samples, the third and fourth digital filters being of same type and having same frequency response.

52. The method of claim 51, the first and second digital filters comprising finite impulse response (FIR) filters, and the third and fourth digital filters comprising infinite impulse response (IIR) filters.

53. An apparatus comprising:
at least one processor to filter first inphase (I) samples for an I branch of a transmitter with a first digital filter to obtain I compensated samples, and to filter first quadrature (Q) samples for a Q branch of the transmitter with a second digital filter to obtain Q compensated samples, the I and Q compensated samples being compensated for I/Q imbalances between the I and Q branches of the transmitter at multiple frequencies.

54. The apparatus of claim 53, the at least one processor further generates the first I samples based on I output samples for the I branch and scaled Q output samples, and generates the first Q samples based on Q output samples for the Q branch and scaled I output samples, the first I and Q samples being compensated for frequency-independent I/Q imbalance between the I and Q branches of the transmitter, and the I and Q compensated samples being compensated for frequency-dependent and frequency-independent I/Q imbalances between the I and Q branches of the transmitter.

55. The apparatus of claim 53, the at least one processor further obtains frequency response of the I branch of the transmitter, obtains frequency response of the Q branch of the transmitter, determines coefficients of the first digital filter based on the frequency response of the I branch, and determines coefficients of the second digital filter based on the frequency response of the Q branch.
